(19) United States
(12) Patent Application Publication
(10) Pub. No.: US 2023/0036372 A1
(43) Pub. Date: Feb. 2, 2023

(54) ROOFING TILE COATING COMPOSITIONS

(71) Applicant: Celanese International Corporation, Irving, TX (US)

(72) Inventors: Matthias JUNK, Hahnlein (DE); Ulrich DESOR, Idstein (DE)

(73) Assignee: Celanese International Corporation, Irving, TX (US)

(21) Appl. No.: 17/783,259

(22) PCT Filed: Jan. 21, 2021
(86) PCT No.: PCT/US2021/014294

§ 371 Date: Jun. 7, 2022

Related U.S. Application Data
(60) Provisional application No. 62/964,426, filed on Jan. 22, 2020.

(51) Int. Cl. C09D 141/00

(52) U.S. Cl. CPC C09D 141/00

(57) ABSTRACT

Coating compositions are useful for applying to surfaces of molding, include concrete moldings such as roofing tile. The coating composition comprise monomers that provide advantageous properties to reduce water uptake as well as improving the aesthetic appearance.

### PRIORITY

This application claims priority to U.S. Provisional Application No. 62/964,426, filed on Jan. 22, 2020, which is incorporated herein by reference.

### FIELD

This disclosure relates to polymer dispersions useful for coating compositions, such as coating compositions applied to concrete moldings, in particular roofing tiles and fiber-filled cement panels.

### BACKGROUND

Various construction materials use protective coatings to ensure longevity and performance, as well as to achieve desirable aesthetic appearance. In particular, concrete moldings and fiber-filled cement panels as well as other types of construction materials obtainable by molding a flowable concrete mixture and then bringing about the setting of the molded mixture may use protective coatings. Examples of concrete moldings are concrete pipes, e.g., those for grey water, sewage, or waste water, curbstones, jersey walls, floor slabs, floor baseplates, base slabs, stair steps and treads, walling components and concrete roofing tiles. Cement panels may be filled with organic or inorganic fibers. Concrete roofing tiles are concrete moldings in the shape of roofing tiles, and have achieved widespread use over other types of materials, such as clay, for covering roofs.

A dispersion-based paint may be applied to the construction materials by a conventional technique, such as spraying, in a two-step process. In the first step the wet (“green”) concrete mold is coated with a first layer of the dispersion-based paint. After curing the concrete mold in drying ovens at a temperature from 40° C. to 100° C. for several hours, a second layer of the dispersion-based paint (which may be the same or different) is applied onto the dry concrete molds. Such dispersion-based paints are compatible with concrete materials and provide many advantages such as inhibiting efflorescence of the concrete molds upon water exposure, forming defect-free thin paint films, and allowing for collection and re-use of the overspray. In view of these properties, the dispersion-based paints are suitable for both coating steps of the process.

One concern for moldings, in particular concrete molding, is that exposure to environmental factors due to weathering (including moisture) causes leaching of the cationic constituents, such as Ca′. The leaching adversely affects the strength and is referred to as the efflorescence phenomena. As understood, this phenomena is attributable to the cations, such as Ca′, reacting with the carbon dioxide to form unsightly white lime stains. Efflorescence is not limited to exposure once deployed but may also occur during the hardening of moldings.

U.S. Pat. No. 8,334,350 relates to an aqueous polymer dispersion whose dispersed addition polymer P comprises, copolymerized in free-radically polymerized form, at least one polar monomer having a water solubility of greater than 50 g/liter (measured at 20° C.), and obtainable by free-radically initiated aqueous emulsion polymerization, the polar monomer being metered to the reaction mixture during the polymerization process at a variable rate.

U.S. Pat. No. 6,709,710 describes a method for producing coated mineral shaped bodies by applying an aqueous coating agent containing a polymer dispersion serving as a bonding agent and at least one aqueous styrene maleic anhydride copolymer solution. The shaped body is subsequently hardened and the coating agent is dried. This description states that the aqueous styrene maleic anhydride copolymer solution is added to the polymer dispersion after completion of the polymerization. The shaped bodies coated in such a manner exhibit an improved efflorescence behavior. The method described by this reference is particularly suited for coating roofing tiles and fibrated concrete slabs.

U.S. Pat. No. 6,306,460 describes a process for preserving a mineral molding by coating the surface of the mineral molding with an aqueous composition comprising an aqueous polymer dispersion, the dispersed polymer comprises an ethylenically unsaturated acid of the 2-acrylamido-2-methylpropane sulfonic acid type polymerized into it in free-radically polymerized form.

U.S. Pat. No. 4,558,092 describes an aqueous plastics dispersion that is manufactured by copolymerization of several olefinically unsaturated monomers, one of them at least being free from amide and sulfo groups, one of them at least having an amide group and one of them at least having a sulfo group. Copolymerization is carried out in an aqueous medium under usual conditions. The resulting copolymer has a second order transition temperature of 20° C. at most. The described plastics dispersion is compatible with cement and serves as additive in cement-containing building materials.

Despite the success of these dispersion-based paints and additives, further improvements are sought to overcome deficiencies. Specifically, the dispersion-based coatings are prone to a high gravimetric water uptake. The intermittently incorporated water enables fungi and algae to grow and decreases the aesthetics and lifetime of the concrete roof tiles. To prevent fungal and algal growth, film preservatives, which includes biocides, are added into the coatings. However, despite intricate encapsulation techniques, the film preservatives are gradually washed out of the coatings and thus only decelerate the microbiological growth on roof tiles. Further, aquatoxic substances are released into the environment through the washout of these film preservatives. Hence, roof tile manufacturers are searching for coating compositions that allow the reduction or even removal of film preservatives from roof tiles.

Although existing dispersion-based paints are highly efficient, further improvements are desirable.

### SUMMARY

It is therefore embodiments of the present disclosure to provide an improved coating composition comprising the polymer dispersions described herein and a process for preserving a construction molding, e.g., a roofing tile, by applying the coating composition thereto.

In one embodiment of the present disclosure there is provided a process for preserving a molding, which includes a roofing tile, by coating at least one surface of the molding with a composition comprising a polymer dispersion, the polymer dispersion comprising at least one monomer of formula I:

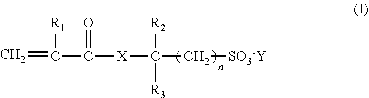

wherein, n is from 0 to 10,
R₁, R₂, and R₃ are, independently of one another, hydrogen or methyl,
X is oxygen or imino, and
Y is hydrogen, alkali metal, or ammonium,

and at least one monomer having an amidic functionality, wherein the weight ratio of the at least one monomer having an amidic functionality to the at least one monomer of formula I is greater than 1, e.g. preferably greater than 1.5, and the total combined weight of the at least one monomer having an amidic functionality and the at least one monomer of formula I is from 1 to 2.5 wt. %, e.g. preferably from 1.25 to 2 wt. %, based on the total amount of monomers in the polymer dispersion. In one embodiment, the monomer having an amidic functionality may be from 0.2 to 0.8 wt. %, based on the total amount of monomers in the polymer dispersion. The monomer having an amidic functionality may comprise methacrylamide or acrylamide. The total loading of the monomer of formula I may be from 0.2 to 0.8 wt. %, based on the total amount of monomers in the polymer dispersion. In addition, the monomer of formula I may be 2-acrylamido-2-methylpropanesulfonic acid or an alkali metal or ammonium salt thereof. The polymer dispersion may comprise at least one alkyl ester monomer and in an amount of no less than 50 wt. %, based on the total amount of monomers in the polymer dispersion. In one embodiment, the polymer dispersion comprises at least one alkyl ester monomer of an acrylic and methacrylic acid with alkanols having from 1 to 12 carbon atoms. In one embodiment, the polymer dispersion may contain no or low amounts of monomers having carboxylic acid functionality and vinyl aromatic monomers. The polymer dispersion may comprise no more than 0.5 wt. % of monomers having carboxylic acid functionality. The polymer dispersion may also comprise no more than 5 wt. % of vinyl aromatic monomers. The polymer dispersion may have a glass transition (Tg) temperature that is equal to or greater than 20° C., as determined by differential scanning calorimetry according to ISO 16805. The coating composition may also comprise pigments, fillers, and/or auxiliaries, etc., but preferably comprises less than 0.01 wt. % of film preservatives employed to prevent fungal and algal growth, based on the total weight of the coating composition.

In another embodiment of the present disclosure there is provided a process for preserving a construction molding, which may include a roofing tile, by coating at least one surface of the construction molding with the coating composition comprising a dispersion (polymer dispersion) formed from a monomer composition of:

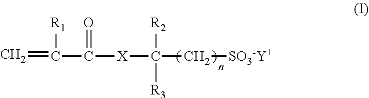

wherein, n is from 0 to 10,
R₁, R₂, and R₃ are, independently of one another, hydrogen or methyl,
X is oxygen or imino, and
Y is hydrogen, alkali metal, or ammonium,

and at least one monomer having an amidic functionality, wherein the weight ratio of the at least one monomer having an amidic functionality to the at least one monomer of formula I is greater than 1, e.g. preferably greater than 1.5, and the total combined weight of the at least one monomer having an amidic functionality and the at least one monomer of formula I is from 1 to 2.5 wt. %, e.g. preferably from 1.25 to 2 wt. %, based on the total amount of monomers in the polymer dispersion, and/or the coating composition may comprise one or more pigments, fillers, and/or auxiliaries. In one embodiment, the coating composition may comprise less than 0.01 wt. % of film preservatives employed to prevent fungal and algal growth, based on the total weight of the coating composition. In one embodiment, the monomer having an amidic functionality may be from 0.2 to 0.8 wt. %, based on the total amount of monomers in the polymer dispersion. The monomer having an amidic functionality may comprise methacrylamide or acrylamide. The total loading of the monomer of formula I may be from 0.2 to 0.8 wt. %, based on the total amount of monomers in the polymer dispersion. In addition, the monomer of formula I may be 2-acrylamido-2-methylpropanesulfonic acid or an alkali metal or ammonium salt thereof. The polymer dispersion may comprise at least one alkyl ester monomer and in an amount of no less than 50 wt. %, based on the total amount of monomers in the polymer dispersion. In one embodiment, the polymer dispersion comprises at least one alkyl ester monomer of an acrylic and methacrylic acid with alkanols having from 1 to 12 carbon atoms. In one embodiment, the polymer dispersion may contain no or low amounts of monomers having carboxylic acid functionality and vinyl aromatic monomers. The polymer dispersion may comprise no more than 0.5 wt. % of monomers having carboxylic acid functionality. The polymer dispersion may also comprise no more than 5 wt. % of vinyl aromatic monomers. The polymer dispersion may have a glass transition (Tg) temperature that is equal to or greater than 20° C., as determined by differential scanning calorimetry according to ISO 16805.

In another embodiment of the present disclosure there is provided a coating composition comprising a dispersion (polymer dispersion) formed from a monomer composition of:

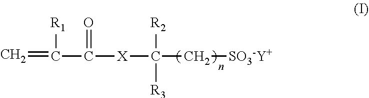

wherein, n is from 0 to 10,
R₁, R₂, and R₃ are, independently of one another, hydrogen or methyl,
X is oxygen or imino, and
Y is hydrogen, alkali metal, or ammonium,

and at least one monomer having an amidic functionality, wherein the weight ratio of the at least one monomer having an amidic functionality to the at least one monomer of formula I is greater than 1, e.g. preferably greater than 1.5, and the total combined weight of the at least one monomer having an amidic functionality and the at least one monomer of formula I is from 1 to 2.5 wt. %, e.g. preferably from 1.25 to 2 wt. %, based on the total amount of monomers in the polymer dispersion, and/or the coating composition may comprise at least one alkyl ester monomer and/or the coating composition comprises one or more pigments, fillers, and/or auxiliaries. The alkyl ester monomer may be in an amount of no less than 50 wt. %, based on the total amount of monomers in the polymer dispersion. In one embodiment, the polymer dispersion comprises at least one alkyl ester monomer of an acrylic and methacrylic acid with alkanols having from 1 to 12 carbon atoms. In one embodiment, the coating composition may comprise less than 0.01 wt. % of film preservatives employed to prevent fungal and algal growth, based on the total weight of the coating composition. In one embodiment, the monomer having an amidic functionality may be from 0.2 to 0.8 wt. %, based on the total amount of monomers in the polymer dispersion. The monomer having an amidic functionality may comprise methacrylamide or acrylamide. The total loading of the monomer of formula I may be from 0.2 to 0.8 wt. %, based on the total amount of monomers in the polymer dispersion. In addition, the monomer of formula I may be 2-acrylamido-2-methylpropanesulfonic acid or an alkali metal or ammonium salt thereof. In one embodiment, the polymer dispersion may contain no or low amounts of monomers having carboxylic acid functionality and vinyl aromatic monomers. The polymer dispersion may comprise no more than 0.5 wt. % of monomers having carboxylic acid functionality. The polymer dispersion may also comprise no more than 5 wt. % of vinyl aromatic monomers. The polymer dispersion may have a glass transition (Tg) temperature that is equal to or greater than 20° C., as determined by differential scanning calorimetry according to ISO 16805.

The present inventors conducted diligent and intensive studies to achieve the above features; as a result of those studies, the following composition and processes have been developed.

### DETAILED DESCRIPTION

The details of the polymer dispersions will be described herein with context to the various embodiments.

The polymer dispersions described herein are used in a coating composition, such as paints, for preserving a molding, such as concrete roofing tiles, by coating at least one surface of the molding. The coating composition comprises a polymer dispersion of monomers that enhance the compositions' hydrophobic properties. In one embodiment, the polymer dispersion is formed from monomers that comprises at least one monomer of formula I:

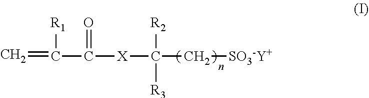

wherein, n is from 0 to 10, preferably from 0 to 2,
R₁, R₂, and R₃ are, independently of one another, hydrogen or methyl,
X is oxygen or imino, and
Y is hydrogen, alkali metal, or ammonium,

and at least one monomer having an amidic functionality, wherein the weight ratio of the at least one monomer having an amidic functionality to the at least one monomer of formula I is greater than 1 and the total combined weight of the at least one monomer having an amidic functionality and the at least one monomer of formula I is from 1 to 2.5 wt. %, based on the total amount of monomers in the polymer dispersion. As described herein the combination of this specific ratio and total weight provide surprising and unexpected benefits to the coating composition.

One advantage of the polymer dispersions described herein with the embodiments of the present invention is the reduced water absorption due to the increased hydrophobic characteristics. Exposure to moisture is inevitable for construction materials, particular those which have a long planned useful life. Water absorption can result in embrittlement of the coating and decreased protection. In particular construction materials are exposed to freeze/thaw cycling that increases the susceptibility to cracking. The dispersion paints described herein do not suffer from the water absorption problems of conventional paints and demonstrate excellent ability to reduce the gravimetric water uptake. By achieving this, the dispersions are able to reduce microbiological growth, even without an effective amount of a film preservative, such as a biocide. In one embodiment, the polymer dispersions produce efflorescence resistant coatings on moldings, and in particular, on concrete moldings. Further aesthetic appearance may be improved by decrease cracking and chipping which is common when water is absorbed.

The dispersions described herein are suitable for being applied, e.g., through coating at least one surface, on various construction materials including moldings. For the purposes of this disclosure, the dispersions may be described as being applied to roofing tiles, however, it should be understood that the application to roofing tiles is not particularly limited.

The polymer dispersions described according to the embodiments disclosed herein are aqueous dispersions formed from homogeneous mixtures where each of the monomers is admixed.

Monomers for Polymer Dispersion

Turning now to the monomers of the dispersions described herein, in some embodiments, the polymer dispersions are formed from at least one monomer of formula I:

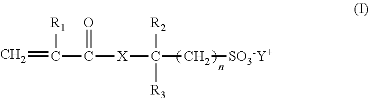

wherein, n is from 0 to 10, preferably from 0 to 2,
R₁, R₂, and R₃ are, independently of one another, hydrogen or methyl,
X is oxygen or imino, and
Y is hydrogen, alkali metal, or ammonium.

Particularly suitable alkali metal salts of the monomers of formula I are the sodium and potassium salts.

Formula I includes monomers that comprise sulfonic acids linked to acrylic or methacrylic acid via an ester group or an amide group, including the alkali metal and ammonium salts. Various examples of compounds contemplated within formula I include 3-sulfopropylacrylate, 3-sulfopropylmethacrylate, 2-sulfoethylacrylate, 2-sulfoethylmethacrylate, 2-acrylamido-2-methylpropanesulfonate, 2-methacrylamino-2,2-dimethylethanesulfonic acid, 2-acrylamido-ethanesulfonic acid, 2-methacrylamido-ethanesulfonic acid, 2-acrylamido-2-methylpropanesulfonic acid, 2-acrylamido-n-butanesulfonic acid, 2-methacrylamido-n-butanesulfonic acid, 2-methacrylamido-isobutanesulfonic acid and 2-acrylamido-2,2-dimethylethanesulfonic acid, and the alkali and ammonium salts thereof.

In one embodiment, the monomers of formula I may include:

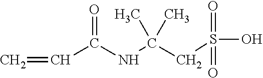

or its alkali metal or ammonium salt (2-acrylamido-2-methylpropanesulfonic acid).

In one embodiment, the polymer dispersions are formed from at least one monomer having an amidic functionality. These monomers include olefinically unsaturated monomer having an amide group or an amide of an olefinically unsaturated monocarboxylic acid having from 3 to 8 carbon atoms, or in particular from 3, 4 or 5 carbon atoms. In particular, such monomers may include acrylamide, methacrylamide, crotonic acid amide, or combinations thereof. Particular useful monomers with amidic functionality include acrylamide, methacrylamide, or combinations thereof. Due to not being carcinogenic, methacrylamide is the most preferred monomer with amidic functionality.

To achieve the desired property of hydrophobicity, the present inventors have made several studies of these monomers and found that the weight ratio of the monomer having an amidic functionality to the monomers of formula I provides a useful contribution. Thus, to achieve low water uptake, in one embodiment, the dispersion has a weight ratio of the monomer having an amidic functionality to the monomers of formula I that is greater than 1, e.g., greater than 1.5 or greater than 2. This provides a relative excess of the monomers having an amidic functionality. In addition, the total combined amount of monomers with amidic functionality and monomers according to formula I is from 1 to 2.5 wt. %, based on the total amount of monomers in the polymer dispersion, e.g., from 1.25 to 2 wt. %, or from 1.4 to 1.8 wt. %. Under such loadings and within the ratios the dispersions described herein demonstrate a superior low water uptake, as well as improved efflorescence.

Within this context, in one embodiment, the dispersions comprise the monomers of formula I in an amount from 0.2 to 0.8 wt. %, based on the total amount of monomers in the polymer dispersion, e.g., from 0.25 to 0.5 wt. %, and monomers having an amidic functionality in an amount from 0.5 to 2.0 wt. %, e.g., from 0.75 to 1.5 wt. %, provided that the ratios and total combined amounts disclosed herein are satisfied. When the dispersion contains 0.5 wt. % of the monomers of formula I, such as 2-acrylamido-2-methylpropanesulfonic acid, the dispersion may also comprise from more than 0.5 wt. % to 2.0 wt. % of monomers having an amidic functionality, such as acrylamide or methacrylamide.

In addition to the monomers of formula I and monomers having an amidic functionality, the polymer dispersions also comprise one or more main monomers. The main monomers may vary depending on the use and application of the polymer dispersion. In some embodiments, the polymer dispersions are formed from main monomers comprising at least one alkyl ester monomer of olefinically unsaturated monocarboxylic acids, at least one monomer of formula I as described herein, and at least one monomer having an amidic functionality as described herein.

In one embodiment, the polymer dispersions are formed from alkyl ester monomers of olefinically unsaturated monocarboxylic acids. These alkyl ester monomers may comprise no less than 50 wt. % of the total amount of monomers in the polymer dispersion, e.g., no less than 75 wt. % or no less than 90 wt. %. In terms of ranges, the alkyl ester monomers may comprise from 50 wt. % to 99 wt. %, e.g., from 75 wt. % to 98.5 wt. % or from 90 to 98 wt. %. In one embodiment, the alkyl ester monomers comprise alkyl esters of acrylic and methacrylic acid with alkanols having from 1 to 12 carbon atoms, e.g., from 3 to 8 carbon atoms. Such ester monomers include, without limitation, n-butyl acrylate, n-hexyl acrylate, 2-ethylhexyl acrylate, n-octyl acrylate, lauryl acrylate, tridecyl acrylate, methyl methacrylate, n-butyl methacrylate, n-octyl methacrylate, 2-ethylhexyl methacrylate, lauryl methacrylate, and combinations or mixtures thereof. Preferably, methyl methacrylate and n-butyl acrylate are selected as main monomers.

To prepare the dispersions according to the present disclosure, it is preferred to avoid forming the dispersion without monomers having carboxylic acid functionality. Such monomers reduce the efflorescence resistance of the dispersion. Therefore, the dispersions disclosed herein are preferably prepared with no more than 0.5 wt. % of these optional co-monomers having carboxylic acid functionality based on the total amount of monomers in the dispersion, e.g., no more than 0.4 wt. %, no more than 0.25 wt. % or no more than 0.1 wt. %. This can allow, in some embodiments, for the dispersion to be prepared without monomers having carboxylic acid functionality, and this renders the dispersion substantially free of such monomers. Monomers having carboxylic acid functionality may include acrylic acid, methacrylic acid, maleic acid, fumaric acid, itaconic acid and citraconic acid.

In some embodiments, the polymer dispersions should avoid vinyl aromatic monomers, which may include vinyl esters of benzoic acid, substituted derivatives of benzoic acid, such as vinyl p-tert-butylbenzoate, styrene and styrene derivatives. Therefore, the dispersions disclosed herein are prepared with no more than 5 wt. % of vinyl aromatic monomers based on the total amount of monomers in the dispersion, e.g., no more than 4 wt. %, no more than 3 wt. % or no more than 1 wt. %. In some embodiments, the vinyl aromatic monomers can be avoided altogether and this renders the dispersion substantially free of such vinyl aromatic monomers. Thus, such polymer dispersions are substantially styrene-free, i.e. they contain no measurable amount of styrene.

Although the dispersions may incorporate monomers of polyvinyl chloride, it is generally preferred to use these co-monomers in low amounts. While co-monomers of polyvinyl chloride are suitable for dry molding coatings, such co-monomers are poor in coating wet moldings used in the second step of the molding process. The dispersions disclosed herein are suitable for use in both steps and thus it is generally preferred to reduce the monomers of polyvinyl chloride.

The polymer dispersions disclosed herein may be prepared by the customary processes of emulsion polymerization, where the monomers may be emulsified in the aqueous phase in the presence of emulsifiers, initiators, and optionally protective colloids, and are advantageously polymerized at temperatures from 60° C. to 95° C. These processes are familiar to those skilled in the art and may be carried out by batch processes, metered-monomer processes, or emulsion-feed processes. The emulsion-feed process allows a small amount of the monomers to be pre-polymerized and then the remainder of the monomers is metered in the form of an aqueous emulsion. The process may involve polymerization in one, two, and more stages with different monomer combinations. Preferably, a single stage polymerization is performed, producing a homogeneous polymer dispersion with one defined glass transition temperature.

The initiators may include, without limiting the scope of the embodiments of the disclosed invention, one or more free radical initiators. Suitable free radical initiators include hydrogen peroxide, benzoyl peroxide, cyclohexanone peroxide, isopropyl cumyl hydroperoxide, persulfates of potassium, persulfates of sodium and persulfates of ammonium, peroxides of saturated monobasic aliphatic carboxylic acids having an even number of carbon atoms and a C₈-C₁₂ chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl)hexanoyl peroxide, tert-butyl perpivalate, hydroperoxypinane, p-methane hydroperoxide. The above-mentioned compounds can also be used within redox systems, using transition metal salts, such as iron(II) salts, or other reducing agents. Alkali metal salts of oxymethane sulfinic acid, hydroxylamine salts, sodium dialkyldithiocarbamate, sodium bisulfate, ammonium bisulfate, disodium 2-hydroxy-2-sulfinic acetic acid, disodium 2-hydroxy-2-sulfonic acetic acid, sodium dithionite, diisopropyl xanthogen disulfide, ascorbic acid, tartaric acid, and isoascorbic acid can also be used as reducing agents.

Based on the content of polymer, the polymer dispersions preferably comprise no more than 3 wt. %, e.g., no more than 2 wt. %, of ionic emulsifiers, and no more than 4 wt. %, e.g., no more than 2 wt. %, such as no more than 1 wt. %, preferably no more than 0.5 wt. % of nonionic emulsifiers, based on the total amount of monomers.

Examples of suitable nonionic emulsifiers are alkyl polyglycol ethers, e.g., ethoxylation products of lauryl, oleyl, or stearyl alcohol, or mixtures of the same, e.g., coconut fatty alcohol; and ethoxylation products of polypropylene oxide. Also, copolymerizable nonionic surfactants can be employed. Preferably, no alkylphenol ethoxylates are used.

Suitable ionogenic emulsifiers are anionic emulsifiers, e.g., the alkali metal or ammonium salts of alkyl-, aryl- or alkylaryl sulfonates or -phosphonates, or of alkyl, aryl, or alkylaryl sulfates, or of alkyl, aryl, or alkylaryl phosphates, or compounds with other anionic end groups, and it is also possible here for there to be oligo- or polyethylene oxide units between the hydrocarbon radical and the anionic group. Typical examples are sodium lauryl sulfate, sodium undecyl glycol ether sulfate, sodium lauryl diglycol sulfate, sodium tetradecyl triglycol sulfate, sodium dodecylbenzenesulfonate. Also, copolymerizable anionic surfactants may be used. Preferably, no alkylphenol ethoxylates including derivatives thereof are employed.

In some embodiments, the polymer dispersions and compositions containing such dispersions described herein can be substantially free of protective colloids as stabilizing agents. Examples of protective colloids include carboxymethyl cellulose (CMC), hydroxyethyl cellulose (HEC), and polyvinyl alcohol (PVOH). Such polymer dispersions are considered to be “substantially free” of protective colloids when protective colloids comprise no more than 0.5 wt. %, e.g., no more than 0.2 wt. % or no more than 0.1 wt. %, based on the total amount of monomers in the polymer dispersion.

In a particularly preferred embodiment, the dispersions neither comprise protective colloids nor nonionic emulsifiers.

The pH of the polymer dispersions may be controlled to be from 6.5 to 10, e.g., from 7.0 to 9.0. Examples of bases suitable for this purpose are aqueous solutions of the hydroxides of ammonia, of alkali metals, or of alkaline earth metals. It is also possible to use buffers, e.g., sodium hydrogen phosphate, sodium acetate, or sodium hydrogen carbonate, and, where appropriate, these may be used during the emulsion polymerization itself.

The polymer dispersions when polymerized have a glass transition temperature (Tg) that is equal or greater than 20° C., e.g., equal or greater than 25° C., or in the range of 25 to 35° C., as determined by differential scanning calorimetry according to ISO 16805. The polymer dispersions may be prepared under conditions to produce a uniform Tg. The above-mentioned Tg range enables the formulation of paints with improved dirt pick-up resistance.

The particulates of the dispersions have an average diameter, as measured by a combination of laser diffraction and polarization intensity differential scattering (PIDS) using a Beckman Coulter LS 13320 Particle Size Analyzer, from 100 nm to 300 nm, e.g., from 120 nm to 250 nm or from 130 nm to 200 nm. In some embodiments, the particulates may have a substantially uniform particle size distribution.

In one embodiment, the polymer dispersions are coagulum-free and storage stable. By coagulum-free it is meant that the coagulum-free, as measured by filtration over a 180 μm sieve, is no more than 0.05 wt. %, e.g., no more than 0.02 wt. %, or no more than 0.01 wt. %. Having coagulum-free polymer dispersions is generally desirable for producing polymer dispersions on a commercial scale.

The polymer dispersions may have a solids content from 30 wt. % to 70 wt. %, e.g., from 40 wt. % to 60 wt. %, or from 45 wt. % to 55 wt. %.

Coating Compositions

In addition to the polymerized monomers, the coating compositions comprise water, and may also include pigments, fillers, or auxiliaries, including combinations thereof. Pigments and fillers may be added during the polymerization process in a conventional manner and at any convenient point in the preparation of the coating composition.

Pigments may include titanium dioxide, barium sulfate, zinc oxide, and combinations thereof for white pigments. The pigments may comprise colorized pigments such as iron oxides, carbon black, graphite, zinc yellow, zinc green, ultramarine, manganese black, antimony black, manganese violet, Paris blue or Schweinfurt green. Other organic colored pigments may also include, for example, sepia, gamboge, Cassel brown, toluidine red, para red, Hansa yellow, indigo, azo dyes, anthraquinone and indigo dyes as well as dioxazine, quinacridone, phthalocyanin, isoindolinone and metal complex pigments of the azomethine series. Preferably, inorganic iron oxide pigments are used.

Preferred pigment volume concentrations (pvc) of the coating compositions according to the embodiments of the disclosed invention are below the critical pvc, such as below 50%, or preferably below 30%.

Preferred fillers useful in the coating compositions described herein can be, for example, calcium carbonate, magnesite, dolomite, kaolin, mica, talc, silica, calcium sulfate, feldspar, barium sulfate and opaque polymers.

Typical auxiliaries in coating compositions may include various combinations and amounts of antifoams, solvents, plasticizers, dispersing agents, inorganic aggregates, thickeners, rheology modifiers, and/or other auxiliaries usual for formulation coating compositions. Auxiliaries may be added throughout the polymerization process in a conventional manner and at any convenient point in the preparation of the coating composition.

To disperse the fillers and pigments in water, auxiliaries based on anionic or non-ionic dispersing agents (wetting agents), including sodium pyrophosphate, sodium polyphosphate, naphthalenesulfonate, sodium polyacrylate, sodium polymaleinates and polyphosphonates such as sodium 1-hydroxyethane-1,1-diphosphonate and sodium nitrilotris(methylenephosphonate), may be added to the composition.

Thickeners may include those based on polyacrylates and on polyurethanes, which are suitable for aqueous systems. Thickeners which may be used include, without limitation, sodium polyacrylate and water-soluble copolymers based on acrylic and methacrylic acid, such as acrylic acid/acrylamide and methacrylic acid/acrylic ester copolymers. Hydrophobically-modified alkali soluble (acrylic) emulsions (HASE), hydrophobically-modified ethoxylate (poly)urethanes (HEUR), hydrophobically-modified ethoxylate (poly)urethane alkali-swellable/soluble emulsions (HEURASE), polyether polyols (PEPO), and polyurea thickeners are also available. Inorganic thickeners, such as, for example, bentonites or hectorite, may also be used. Commercially available thickeners include Borchigel® L75 and Tafigel® PUR 60, and/or Deuteron® VT 819.

In conventional coating compositions for exterior use, film preservatives are routinely employed to prevent fungal and algal growth and to protect the initial properties of the surface of the coating, as outlined in the Product-Type 7 (PT7) biocide list in the EU Biocidal Products Regulation (528/2012). Due to concerns both health-wise and environmental, regulators have sought to limit or reduce film preservatives, including biocides. Advantageously, the coating compositions containing the polymer dispersions as described herein allow use of significantly less amounts of film preservatives and may avoid the necessity to use film preservatives. This is due to the hydrophobic characteristics of the polymer dispersions that prevent water intrusion and thus decelerates fungal or algal growth. In particular this provides beneficial result since the reduced biocide content corresponds to less leaking into the aquatic environment. In some embodiments, the total loading of film preservatives is less than 0.01 wt. % based on the total weight of the coating composition, e.g., less than 0.005 wt. % or less than 0.0001 wt. %.

Process of Applying Coating Composition

The application rate of the coating composition having the polymer dispersions described herein applied to at least one surface of a molding, such as a roofing tile, may be from 50 to 500 g/m² (calculated wet), e.g., from 70 to 400 g/m², preferably from 100 to 300 g/m². Application to the at least one surface may involve any suitable technique, which includes by spraying, troweling, knife coating, rolling or pouring. The polymer dispersions described herein may be used in coatings applied to both ready-cured and freshly prepared (“green”) moldings. In view of the excellent properties the polymer dispersions described herein provide to the coating compositions, those compositions find particular application for protecting and/or preserving moldings comprising cement as a mineral binder (cast concrete). In a particularly advantageous manner the dispersions, when applied as a coating composition, improve the efflorescence of concrete roofing tiles.

The coating compositions have improved cement stability and allows the coating compositions to be used on a wide range of molding made of cement.

Moldings made of cement are produced from cement mortars whose consistency permits ultimate shaping. They are generally hardened at temperatures between 40 and 80° C. After shaping (by extrusion, for example) but generally prior to hardening, the concrete roofing tiles are coated superficially with an aqueous composition formed from monomers according with the embodiments of the disclosed invention, and then stored for 6 to 12 hours in curing chambers, in which typically the above-mentioned temperatures prevail. Within this time they cure, and at the same time the coating composition forms a preserving film. In some cases a further application is performed with a coating composition, after the curing operation, with subsequent drying. The same coating composition containing a polymer dispersion formed from the monomers described herein may be used for both steps.

At the outset, it should be noted that in the development of any such actual embodiment, numerous implementation-specific decisions must be made to achieve the developer's specific goals, such as compliance with system related and business related constraints, which will vary from one implementation to another. In addition, the processes disclosed herein can also comprise components other than those cited or specifically referred to, as is apparent to one having average or reasonable skill in the art.

### EMBODIMENTS

As used below, any reference to a series of embodiments is to be understood as a reference to each of those embodiments disjunctively (e.g., “Embodiments 1-4” is to be understood as “Embodiments 1, 2, 3, or 4”).

Embodiment 1 is a coating composition for preserving a molding, the coating composition comprising: a dispersion formed from a monomer composition of: at least one monomer of formula I:

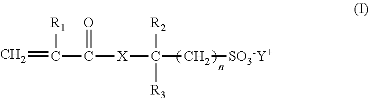

wherein, n is from 0 to 10, preferably from 0 to 2, R₁, R₂, and R₃ are, independently of one another, hydrogen or methyl, X is oxygen or imino, and Y is hydrogen, alkali metal, or ammonium; and at least one monomer having an amidic functionality, wherein the weight ratio of the at least one monomer having an amidic functionality to the at least one monomer of formula I is greater than 1 and the total combined weight of the at least one monomer having an amidic functionality and the at least one monomer of formula I is from 1 to 2.5 wt. %, based on the total amount of monomers in the polymer dispersion; and optionally one or more pigments, fillers, and/or auxiliaries.

Embodiment 2 is the coating composition of embodiment(s) 1, wherein the polymer dispersion comprises at least one alkyl ester monomer of an acrylic and methacrylic acid with alkanols having from 1 to 12 carbon atoms.

Embodiment 3 is the coating composition of embodiment(s) 2, wherein the polymer dispersion comprises no less than 50 wt. % of the at least one alkyl ester monomer, based on the total amount of monomers in the polymer dispersion.

Embodiment 4 is the coating composition as in any one of embodiment(s) 1-3, wherein the at least one monomer having an amidic functionality is methacrylamide or acrylamide.

Embodiment 5 is the coating composition as in any one of embodiment(s) 1-4, wherein the monomer of formula I is 2-acrylamido-2-methylpropanesulfonic acid or an alkali metal or ammonium salt thereof.

Embodiment 6 is the coating composition as in any one of embodiment(s) 1-5, wherein the wherein the weight ratio of the at least one monomer having an amidic functionality to the at least one monomer of formula I is greater than 1.5.

Embodiment 7 is the coating composition as in any one of embodiment(s) 1-6, wherein the total weight of the at least one monomer having an amidic functionality and the at least one monomer of formula I is from 1.25 to 2 wt. %, based on the total amount of monomers in the polymer dispersion.

Embodiment 8 is the coating composition as in any one of embodiment(s) 1-7, wherein the polymer dispersion comprises from 0.2 to 0.8 wt. % of the at least one monomer of formula I, based on the total amount of monomers in the polymer dispersion.

Embodiment 9 is the coating composition as in any one of embodiment(s) 1-8, wherein the polymer dispersion comprises from 0.5 to 2.0 wt. % of the at least one monomer having an amidic functionality, based on the total amount of monomers in the polymer dispersion.

Embodiment 10 is the coating composition as in any one of embodiment(s) 1-9, wherein the polymer dispersion comprises no more than 0.5 wt. % of monomers having carboxylic acid functionality.

Embodiment 11 is the coating composition as in any one of embodiment(s) 1-10, wherein the polymer dispersion comprises no more than 5 wt. % of vinyl aromatic monomers.

Embodiment 12 is the coating composition as in any one of embodiment(s) 1-11, wherein the coating composition comprises less than 0.01 wt. % of film preservatives employed to prevent fungal and algal growth, based on the total weight of the coating composition.

Embodiment 13 is the coating composition as in any one of embodiment(s) 1-12, wherein the polymer dispersion has a glass transition temperature that is equal to or greater than 20° C., as determined by differential scanning calorimetry according to ISO 16805.

Embodiment 14 is a process for preserving a construction molding by coating at least one surface of the construction molding with the coating composition as in any preceding claim.

Embodiment 15 is the process of embodiment(s) 14, wherein the construction molding is a roofing tile.

Embodiment 16 is a process for preserving a molding by coating at least one surface of the molding with a composition comprising a polymer dispersion, the polymer dispersion comprising at least one monomer of formula I:

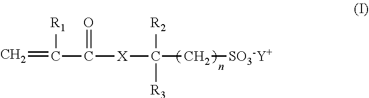

wherein, n is from 0 to 10, R₁, R₂, and R₃ are, independently of one another, hydrogen or methyl, X is oxygen or imino, and Y is hydrogen, alkali metal, or ammonium, and at least one monomer having an amidic functionality, wherein the weight ratio of the at least one monomer having an amidic functionality to the at least one monomer of formula I is greater than 1 and the total combined weight of the at least one monomer having an amidic functionality and the at least one monomer of formula I is from 1 to 2.5 wt. %, based on the total amount of monomers in the polymer dispersion.

Embodiment 17 is the process of embodiment(s) 16, wherein the at least one monomer having an amidic functionality is methacrylamide or acrylamide.

Embodiment 18 is the process as in any one of embodiment(s) 16 and 17, wherein the monomer of formula I is 2-acrylamido-2-methylpropanesulfonic acid or an alkali metal or ammonium salt thereof.

Embodiment 19 is the process as in any one of embodiment(s) 16-18, wherein the wherein the weight ratio of the at least one monomer having an amidic functionality to the at least one monomer of formula I is greater than 1.5.

Embodiment 20 is the process as in any one of embodiment(s) 16-19, wherein the total weight of the at least one monomer having an amidic functionality and the at least one monomer of formula I is from 1.25 to 2 wt. %, based on the total amount of monomers in the polymer dispersion.

Embodiment 21 is the process as in any one of embodiment(s) 16-20, wherein the polymer dispersion comprises from 0.2 to 0.8 wt. % of the at least one monomer of formula I, based on the total amount of monomers in the polymer dispersion.

Embodiment 22 is the process as in any one of embodiment(s) 16-21, wherein the polymer dispersion comprises from 0.5 to 2.0 wt. % of the at least one monomer having an amidic functionality, based on the total amount of monomers in the polymer dispersion.

Embodiment 23 is the process as in any one of embodiment(s) 16-22, wherein the polymer dispersion comprises at least one alkyl ester monomer of an acrylic and methacrylic acid with alkanols having from 1 to 12 carbon atoms.

Embodiment 24 is the process of embodiment(s) 23, wherein the polymer dispersion comprises no less than 50 wt. % of the at least one alkyl ester monomer, based on the total amount of monomers in the polymer dispersion.

Embodiment 25 is the process as in any one of embodiment(s) 16-24, wherein the polymer dispersion comprises no more than 0.5 wt. % of monomers having carboxylic acid functionality.

Embodiment 26 is the process as in any one of embodiment(s) 16-25, wherein the polymer dispersion comprises no more than 5 wt. % of vinyl aromatic monomers.

Embodiment 27 is the process as in any one of embodiment(s) 16-26, wherein the polymer dispersion has a glass transition temperature that is equal to or greater than 20° C., as determined by differential scanning calorimetry according to ISO 16805.

Embodiment 28 is a coating composition for preserving a molding, the coating composition comprising: a dispersion formed from a monomer composition of: at least one monomer of formula I:

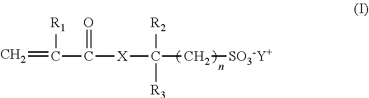

wherein, n is from 0 to 10, R₁, R₂, and R₃ are, independently of one another, hydrogen or methyl, X is oxygen or imino, and Y is hydrogen, alkali metal, or ammonium; and at least one monomer having an amidic functionality, wherein the weight ratio of the at least one monomer having an amidic functionality to the at least one monomer of formula I is greater than 1 and the total combined weight of the at least one monomer having an amidic functionality and the at least one monomer of formula I is from 1 to 2.5 wt. %, based on the total amount of monomers in the polymer dispersion; and one or more pigments, fillers, and/or auxiliaries.

Embodiment 29 is the coating composition of embodiment(s) 28, wherein the monomer of formula I is 2-acrylamido-2-methylpropanesulfonic acid or an alkali metal or ammonium salt thereof.

Embodiment 30 is the coating composition as in any one of embodiment(s) 28 and 29, wherein the wherein the weight ratio of the at least one monomer having an amidic functionality to the at least one monomer of formula I is greater than 1.5.

Embodiment 31 is the coating composition as in any one of embodiment(s) 28-30, wherein the total combined weight of the at least one monomer having an amidic functionality and the at least one monomer of formula I is from 1.25 to 2 wt. %, based on the total amount of monomers in the polymer dispersion.

Embodiment 32 is the coating composition as in any one of embodiment(s) 28-31, wherein the polymer dispersion comprises from 0.2 to 0.8 wt. % of the at least one monomer of formula I, based on the total amount of monomers in the polymer dispersion and from 0.5 to 2.0 wt. % of the at least one monomer having an amidic functionality, based on the total amount of monomers in the polymer dispersion.

Embodiment 33 is the coating composition as in any one of embodiment(s) 28-32, wherein the polymer dispersion comprises no less than 50 wt. % at least one alkyl ester monomer of an acrylic and methacrylic acid with alkanols having from 1 to 12 carbon atoms, based on the total amount of monomers in the polymer dispersion.

Embodiment 34 is the coating composition as in any one of embodiment(s) 28-33, wherein the polymer dispersion comprises no more than 0.5 wt. % of monomers having carboxylic acid functionality and/or no more than 5 wt. % of vinyl aromatic monomers.

Embodiment 35 is the coating composition as in any one of embodiment(s) 28-34, wherein the coating composition comprises less than 0.01 wt. % of film preservatives employed to prevent fungal and algal growth, based on the total weight of the coating composition.

### EXAMPLES

The present invention will be better understood in view of the following non-limiting examples. First, two inventive polymer dispersions and three comparative dispersions are prepared as follows. Next, similar coating compositions were prepared with the polymer dispersions and tested for water uptake.

### Example 1 (Inventive)

A 3 liter reactor equipped with a reflux condenser and an anchor stirrer was filled with 583 g of deionized (DI) water and 6 g of a 28% aqueous solution of a sodium undecyl ether sulfate with approx. 7 moles ethylene oxide. The reactor content was heated to 80° C. and 4% of the monomer feed was added. The monomer feed was obtained by mixing the ingredients in Table 1 under stirring. A solution of 0.6 g sodium persulfate in 11 g of water was added and the reactor contents were held at 80° C. for 15 min. Subsequently, the remaining amount of the monomer feed was added to the reactor with a constant dosage rate over 150 min. The reactor temperature was maintained at 80° C. during the feed addition. After completion of the feed addition, the reactor content was held at 80° C. for another 60 minutes and then cooled to room temperature.

A polymer dispersion with a solid content of 50.1% and a pH of 7.0 was obtained. The coagulum content, as measured by filtration over a 180 μm sieve, was 0.006%. The glass transition temperature, as measured by differential scanning calorimetry (DSC) according to ISO 16805, was 20.2° C.

### Example 2 (Inventive)

A 3 liter reactor equipped with a reflux condenser and an anchor stirrer was filled with 583 g of DI water and 6 g of a 28% aqueous solution of a sodium undecyl ether sulfate with approx. 7 moles ethylene oxide. The reactor content was heated to 80° C. and 4% of the monomer feed was added. The monomer feed was obtained by mixing the ingredients in Table 1 under stirring. A solution of 0.6 g sodium persulfate in 11 g of water was added and the reactor contents were held at 80° C. for 15 min. Subsequently, the remaining amount of the monomer feed was added to the reactor with a constant dosage rate over 150 min. The reactor temperature was maintained at 80° C. during the feed addition. After completion of the feed addition, the reactor content was held at 80° C. for another 60 minutes and then cooled to room temperature.

A polymer dispersion with a solid content of 50.0% and a pH of 7.0 was obtained. The coagulum content, as measured by filtration over a 180 μm sieve, was 0.009%. The glass transition temperature, as measured by differential scanning calorimetry (DSC) according to ISO 16805, was 23.7° C.

### Example 3 (Comparative)

A 3 liter reactor equipped with a reflux condenser and an anchor stirrer was filled with 583 g of DI water and 19.5 g of a 28% aqueous solution of a sodium undecyl ether sulfate with approx. 7 moles ethylene oxide. The reactor content was heated to 80° C. and 4% of the monomer feed was added. The monomer feed was obtained by mixing the ingredients in Table 1 under stirring. A solution of 0.6 g sodium persulfate in 11 g of water was added and the reactor contents were held at 80° C. for 15 min. Subsequently, the remaining amount of the monomer feed was added to the reactor with a constant dosage rate over 150 min. The reactor temperature was maintained at 80° C. during the feed addition. After completion of the feed addition, the reactor content was held at 80° C. for another 60 minutes and then cooled to room temperature.

A polymer dispersion with a solid content of 50.1% and a pH of 6.9 was obtained. The coagulum content, as measured by filtration over a 180 μm sieve, was 0.002%. The glass transition temperature, as measured by differential scanning calorimetry (DSC) according to ISO 16805, was 21.5° C.

### Example 4 (Comparative)

A 3 liter reactor equipped with a reflux condenser and an anchor stirrer was filled with 583 g of DI water and 19.5 g of a 28% aqueous solution of a sodium undecyl ether sulfate with approx. 7 moles ethylene oxide. The reactor content was heated to 80° C. and 4% of the monomer feed was added. The monomer feed was obtained by mixing the ingredients in Table 1 under stirring. A solution of 0.6 g sodium persulfate in 11 g of water was added and the reactor contents were held at 80° C. for 15 min. Subsequently, the remaining amount of the monomer feed was added to the reactor with a constant dosage rate over 150 min. The reactor temperature was maintained at 80° C. during the feed addition. After completion of the feed addition, the reactor content was held at 80° C. for another 60 minutes and then cooled to room temperature.

A polymer dispersion with a solid content of 48.9% and a pH of 7.2 was obtained. The coagulum content, as measured by filtration over a 180 μm sieve, was 1.58%. The glass transition temperature, as measured by differential scanning calorimetry (DSC) according to ISO 16805, was 22.3° C.

### Example 5 (Comparative)

A 3 liter reactor equipped with a reflux condenser and an anchor stirrer was filled with 561 g of DI water and 19.5 g of a 28% aqueous solution of a sodium undecyl ether sulfate with approx. 7 moles ethylene oxide. The reactor content was heated to 80° C. and 4% of the monomer feed was added. The monomer feed was obtained by mixing the ingredients in Table 1 under stirring. A solution of 0.6 g sodium persulfate in 11 g of water was added and the reactor contents were held at 80° C. for 15 min. Subsequently, the remaining amount of the monomer feed was added to the reactor with a constant dosage rate over 150 min. The reactor temperature was maintained at 80° C. during the feed addition. After completion of the feed addition, the reactor content was held at 80° C. for another 60 minutes and then cooled to room temperature.

A polymer dispersion with a solid content of 50.0% and a pH of 6.9 was obtained. The coagulum content, as measured by filtration over a 180 μm sieve, was 0.002%. The glass transition temperature, as measured by differential scanning calorimetry (DSC) according to ISO 16805, was 18.1° C.

TABLE 1
Composition of the monomer feeds (in grams)

| | Ex. 1 | Ex. 2 | Ex.3 | Ex. 4 | Ex. 5 |
|---|---|---|---|---|---|
| DI water | 495 | 495 | 495 | 495 | 495 |
| Sodium alkyl ether sulfate, | 27 | 27 | 27 | 27 | 27 |
| with approx. 7 moles EO, | | | | | |
| 28% in water | | | | | |
| Oxoalcohol polyethylene | 8 | 8 | 8 | 8 | 8 |
| glycol ether with approx. | | | | | |
| 30 moles EO, 70% in water | | | | | |
| Sodium persulfate | 3 | 3 | 3 | 3 | 3 |
| Sodium bicarbonate | 2 | 2 | 2 | 2 | 2 |
| Methacrylamide | 16.5 | 11 | 22 | 22 | 0 |
| Sodium 2-acrylamido-2- | 5.5 | 11 | 33 | 0 | 33 |
| methylpropane sulfonate, | | | | | |
| 50% in water | | | | | |
| Methyl methacrylate (MMA) | 594 | 594 | 594 | 594 | 594 |
| n-butylacrylate (BA) | 506 | 506 | 506 | 506 | 506 |

### Examples 6-10 (Inventive and Comparative Roofing Tile Paints)

Roofing tile paints were prepared by mixing the ingredients in Table 2 at room temperature under stirring. After dissolving and dispersing pos. 2-5, pigment and fillers as per pos. 6-10 were dispersed consecutively by increasing the dissolver speed to 5000 rpm. After the preparation of the mill base, pos. 11-15 were added while gently stirring. Positions 12-15 were pre-mixed before their addition and the solid contents of all polymer dispersions were adjusted to 48.5% before their addition.

TABLE 2
Composition of the roofing tile paints

| | | | Parts per |
|---|---|---|---|
| | | | thousand |
| Pos. | Component (Supplier) | Description | weight |
| 1 | Water | | 90.6 |
| 2 | Deuteron ™ VT 819 (Deuteron) | Xanthan Gum | 0.4 |
| 3 | Lopon ™ 890 (BK Giulini) | Dispersing agent | 1 |
| 4 | AMP-90 ™ (Angus) | Base/wetting agent | 2 |
| 5 | Disperbyk-190 (Byk) | Dispersing agent | 6 |
| 6 | Finntalc M 15 (Elementis) | Talc | 20 |
| 7 | Omyacarb ® 2 GU (Omya) | Calcium carbonate | 108 |
| 8 | Omyacarb ® 5 GU (Omya) | Calcium carbonate | 108 |
| 9 | Bayferrox ® 960 (Lanxess) | Iron oxide | 50 |
| 10 | Bayferrox ® 110 (Lanxess) | Iron oxide | 10 |
| 11 | Dispersion per Ex. 1-5 | | 562 |
| 12 | Water | | 20 |
| 13 | Byk-044 (Byk) | Defoamer | 1 |
| 14 | Butyl CARBITOL ™ (Dow) | Coalescent | 20 |
| 15 | Tafigel ® PUR 60 (Miinzing) | Rheology modifier | 1 |

To assess their gravimetric water uptake, the roof tile paints were applied to a PE foil at a wet film thickness of 600 μm. After drying for 24 h at room temperature and for 24 h at 50° C., two 5×5 cm squares (duplicate determination) were cut out of the free-standing polymer films and dried for another 3 days at 50° C. before weighting (m_{dry,1}). The squares were then put in a petri dish and immersed in DI water for 96 h. After 24 h, 48 h, 72 h, and 96 h, the water was exchanged and the weight of the film after water uptake was measured (e.g., m_{wet,1,24h}). The first water uptake was calculated by, e.g., WU_{1,24h}(%)=100×(m_{wet,1,24h}−m_{dry,1})/m_{dry,1}. Reported is the mean value of the water uptakes after 24 h, 48 h, 72 h, and 96 h. To determine the second water uptake, the same polymer films were dried for 72 h to determine m_{dry,2}. Those films were then immersed in DI water for another 24 h, 48 h, 72 h, and 96 h to determine m_{wet,2} after several immersion times. The second water uptake is calculated according to the first water uptake. While the magnitude of the first water uptake can be used to assess the hydrophilicity of a new paint film, the magnitude of the second water uptake quantifies the hydrophilicity of an aged paint film.

The first and second water uptakes of roofing tile coatings are listed in Table 3. Those paints formulated with the inventive polymer dispersions exhibit very low water uptakes and are hence very hydrophobic. Such paints are expected to decelerate the growth of microorganisms such as bacteria, fungi and algae due to the reduced abundancy of water.

Another task of the emulsion paint is to prevent lime efflorescence during the setting of the concrete roofing tiles. To assess the efflorescence performance of the paints, cement fiber plates (Eternit®) were pretreated with a 33 wt. % aqueous solution of calcium chloride and dried for 24 h at room temperature. The roofing tile paints were then applied at a wet film thickness of 300 μm and dried for 24 h at room temperature. The coated side of the painted panels was placed above a water bath with a temperature of 60° C. for 7 days in order to promote efflorescence. After drying the panels at room temperature, the degree of efflorescence was assessed (Table 3).

TABLE 3
Performance of the roofing tile paints

| | | 1^{st} water | 2^{nd} water | |
|---|---|---|---|---|
| | Dispersion | uptake | uptake | |
| Paint | as per Ex. | (%) | (%) | Efflorescence |
| 6 (inv.) | 1 | 2.0 | 2.8 | slight |
| 7 (inv.) | 2 | 1.3 | 2.5 | none |
| 8 (comp.) | 3 | 8.8 | 7.2 | slight |
| 9 (comp.) | 4 | 4.3 | 3.8 | marked |
| 10 (comp.) | 5 | 6.1 | 5.3 | none |

Only those paints formulated with the inventive polymer dispersions exhibit a good balance of hydrophobicity (very low water uptake) and efflorescence performance. Comparative paint 9 also exhibits low gravimetric water uptake but does not prevent efflorescence of the roofing tiles. Further, the production of polymer dispersion 4 is not feasible on large scale, due to poor reproducibility, due to high coagulum formation during polymerization. Comparative paints 8 and 10 provide good efflorescence performance but exhibit gravimetric water uptakes significantly above 4%.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the invention.

1. A coating composition for preserving a molding, the coating composition comprising:
a polymer dispersion formed from a monomer composition of:
at least one monomer of formula I: 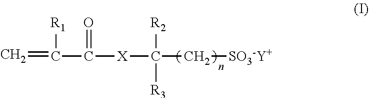
wherein, n is from 0 to 10, preferably from 0 to 2,
R₁, R₂, and R₃ are, independently of one another, hydrogen or methyl,
X is oxygen or imino, and
Y is hydrogen, alkali metal, or ammonium; and
at least one monomer having an amidic functionality, wherein the weight ratio of the at least one monomer having an amidic functionality to the at least one monomer of formula I is greater than 1 and the total combined weight of the at least one monomer having an amidic functionality and the at least one monomer of formula I is from 1 to 2.5 wt. %, based on the total amount of monomers in the polymer dispersion; and optionally one or more pigments, fillers, and/or auxiliaries.

2. The coating composition of claim 1, wherein the polymer dispersion comprises at least one alkyl ester monomer of an acrylic and methacrylic acid with alkanols having from 1 to 12 carbon atoms, wherein the polymer dispersion comprises no less than 50 wt. % of the at least one alkyl ester monomer, based on the total amount of monomers in the polymer dispersion.

3. (canceled)

4. The coating composition of claim 1, wherein the at least one monomer having an amidic functionality is methacrylamide or acrylamide.

5. The coating composition of claim 1, wherein the monomer of formula I is 2-acrylamido-2-methylpropanesulfonic acid or an alkali metal or ammonium salt thereof.

6. The coating composition of claim 1, wherein the weight ratio of the at least one monomer having an amidic functionality to the at least one monomer of formula I is greater than 1.5.

7. The coating composition of claim 1, wherein the total weight of the at least one monomer having an amidic functionality and the at least one monomer of formula I is from 1.25 to 2 wt. %, based on the total amount of monomers in the polymer dispersion.

8. The coating composition of claim 1, wherein the polymer dispersion comprises from 0.2 to 0.8 wt. % of the at least one monomer of formula I, based on the total amount of monomers in the polymer dispersion.

9. The coating composition of claim 1, wherein the polymer dispersion comprises from 0.5 to 2.0 wt. % of the at least one monomer having an amidic functionality, based on the total amount of monomers in the polymer dispersion.

10. The coating composition of claim 1, wherein the polymer dispersion comprises no more than 0.5 wt. % of monomers having carboxylic acid functionality, wherein the polymer dispersion comprises no more than 5 wt. % of vinyl aromatic monomers, wherein the coating composition comprises less than 0.01 wt. % of film preservatives employed to prevent fungal and algal growth, based on the total weight of the coating composition.

11. (canceled)

12. (canceled)

13. The coating composition of claim 1, wherein the polymer dispersion has a glass transition temperature that is equal to or greater than 20° C., as determined by differential scanning calorimetry according to ISO 16805.

14. The coating composition of claim 1, wherein the polymer dispersion comprises from 0.2 to 0.8 wt. % of the at least one monomer of formula I, based on the total amount of monomers in the polymer dispersion and from 0.5 to 2.0 wt. % of the at least one monomer having an amidic functionality, based on the total amount of monomers in the polymer dispersion.

15. A process for preserving a concrete molding by coating at least one surface of the concrete molding with the coating composition according to claim 1.

16. (canceled)

17. A process for preserving a molding by coating at least one surface of the molding with a composition comprising a polymer dispersion, the polymer dispersion comprising at least one monomer of formula I: 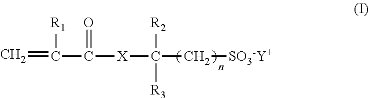
wherein, n is from 0 to 10,
R₁, R₂, and R₃ are, independently of one another, hydrogen or methyl,
X is oxygen or imino, and
Y is hydrogen, alkali metal, or ammonium,
and at least one monomer having an amidic functionality, wherein the weight ratio of the at least one monomer having an amidic functionality to the at least one monomer of formula I is greater than 1 and the total combined weight of the at least one monomer having an amidic functionality and the at least one monomer of formula I is from 1 to 2.5 wt. %, based on the total amount of monomers in the polymer dispersion.

18. The process of claim 17, wherein the at least one monomer having an amidic functionality is methacrylamide or acrylamide.

19. The process of claim 17, wherein the monomer of formula I is 2-acrylamido-2-methylpropanesulfonic acid or an alkali metal or ammonium salt thereof.

20. The process of claim 17, wherein the weight ratio of the at least one monomer having an amidic functionality to the at least one monomer of formula I is greater than 1.5.

21. The process of claim 17, wherein the total weight of the at least one monomer having an amidic functionality and the at least one monomer of formula I is from 1.25 to 2 wt. %, based on the total amount of monomers in the polymer dispersion.

22. The process of claim 17, wherein the polymer dispersion comprises from 0.2 to 0.8 wt. % of the at least one monomer of formula I, based on the total amount of monomers in the polymer dispersion.

23. (canceled)

24. The process of claim 17, wherein the polymer dispersion comprises at least one alkyl ester monomer of an acrylic and methacrylic acid with alkanols having from 1 to 12 carbon atoms.

25. The process of claim 24, wherein the polymer dispersion comprises no less than 50 wt. % of the at least one alkyl ester monomer, based on the total amount of monomers in the polymer dispersion, wherein the polymer dispersion comprises no more than 0.5 wt. % of monomers having carboxylic acid functionality, wherein the polymer dispersion comprises no more than 5 wt. % of vinyl aromatic monomers.

26. (canceled)

27. (canceled)

28. (canceled)
